(19) United States
(12) Patent Application Publication
(10) Pub. No.: US 2019/0275767 A1
(43) Pub. Date: Sep. 12, 2019

(54) STACK STRUCTURE FOR IMPROVED PUNCTURE RESISTANCE

(71) Applicant: CORNING INCORPORATED, CORNING, NY (US)

(72) Inventors: Polly Wanda Chu, Painted Post, NY (US); Timothy Michael Gross, Corning, NY (US); Louis Mattos, JR., Painted Post, NY (US); Timothy Paul Smith, Painted Post, NY (US)

(73) Assignee: CORNING INCORPORATED, Corning, NY (US)

(21) Appl. No.: 16/345,025

(22) PCT Filed: Oct. 24, 2017
(86) PCT No.: PCT/US2017/058030

§ 371 Date: Apr. 25, 2019

Related U.S. Application Data
(60) Provisional application No. 62/413,647, filed on Oct. 27, 2016.

(51) Int. Cl. B32B 17/06; B32B 17/10

(52) U.S. Cl. CPC B32B 17/064; B32B 2307/412; B32B 17/10064

(57) ABSTRACT

A stack assembly including a glass element having a thickness of less than or equal to 200 microns, and a first layer supporting the glass element. The glass element having a first pen drop height value when directly adjacent on a solid aluminum stage. The first layer having a stiffness of from 9×10⁵ N/m to 2.0×10⁶ N/m. When the glass element is supported by the first layer on the aluminum stage, the glass element comprises a second pen drop height value, wherein the second pen drop height value is greater than the first pen drop height value.

### BACKGROUND

### Cross-Reference to Related Applications

This application claims the benefit of priority under 35 U.S.C. § 119 of U.S. Provisional Application Ser. No. 62/413,647 filed on Oct. 27, 2016, the content of which is relied upon and incorporated herein by reference in its entirety.

### FIELD

The present disclosure relates generally to thin glass stack structures and, more particularly, to thin glass stack structures disposed on the user-facing side of devices.

### TECHNICAL BACKGROUND

Currently, thin glass, disposed on the user-facing side of a device, fails at low puncture testing forces due to a local biaxial flexure produced by the testing implement upon impact with the thin glass. One solution has been to use thicker glass that is more resistant to local biaxial flexure, however, in some applications such as in fingerprint sensors the functionality is quite sensitive to the glass thickness. Thus, thicker glass is disadvantageous. Another solution is to put a layer, or multiple layers, of polymeric material on the outer surface of the thin glass to improve puncture resistance. However, this solution has a negative consequence in that the user-facing surface of the device no longer has the hardness (including scratch and chemical resistance) and aesthetics (look and feel) of a glass surface. Accordingly, there is a need for a thin glass structure that can be disposed on the user-facing side of a device and that has improved puncture resistance.

### SUMMARY

The present disclosure sets forth glass stack configurations that dramatically improve the puncture resistance of the thin glass elements, as evidenced by pen drop test failure height increases. The stack configuration includes multiple layers disposed on one side of the thin glass element. A first layer has high stiffness and is coupled to one side of the thin glass element, for example with a thin layer of adhesive, for example pressure sensitive adhesive. The high stiffness of the first layer reduces the local biaxial flexure in the thin glass element during impact events, for example during a puncture test. A second, low stiffness, layer is coupled to the high stiffness first layer, on the same side of the thin glass element. The low stiffness second layer distributes and absorbs energy during the impact event. The glass stack may be used in a variety of applications, particularly where puncture resistance may be beneficial, and where the look and feel or other properties (for example, hermeticity, scratch resistance) of glass are desired. For example, the glass stack may be used in a fingerprint sensor, in a user-facing portion of a device housing, for example in an electronic device housing, in a backsplash, or whiteboard.

The accompanying drawings are included to provide a further understanding of the principles described, and are incorporated in and constitute a part of this specification. The drawings illustrate one or more embodiment(s), and together with the description serve to explain, by way of example, principles and operation of those embodiments. It is to be understood that various features disclosed in this specification and in the drawings can be used in any and all combinations. By way of non-limiting example the various features may be combined with one another as set forth in the following embodiments:

### Embodiment 1

A stack assembly, comprising:

a glass element comprising a thickness of less than or equal to 200 microns, the glass element comprising a first pen drop height value when directly adjacent a solid aluminum stage; and

a first layer adjacent the glass element, the first layer comprising a stiffness of from 9×105 N/m to 2.0×106 N/m,

wherein the glass element comprises a second pen drop height when directly adjacent the first layer which in turn is directly adjacent the solid aluminum stage, and wherein the second pen drop height value is greater than the first pen drop height value.

### Embodiment 2

A stack assembly, comprising:

a glass element comprising a thickness of less than or equal to 200 microns;

a support layer adjacent to the glass element, the support layer comprising a first layer and a second layer, wherein the first layer comprises a first stiffness, and the second layer comprises a second stiffness, wherein the first stiffness is greater than the second stiffness;

wherein when the glass element is disposed on top of the first layer which, in turn, is directly adjacent a solid aluminum stage, the glass element comprises a first pen drop height value; and

wherein when the glass element is disposed on top of the first layer which, in turn, is disposed on top of the second layer which, in turn is directly adjacent the solid aluminum stage, the glass element comprises a second pen drop height value, wherein the second pen drop height value is greater than two times the first pen drop height value.

### Embodiment 3

The stack assembly of embodiment 2, wherein the first stiffness is from 9×105 N/m to 2.0×106 N/m.

### Embodiment 4

The stack assembly of embodiment 1, further comprising a second layer comprising a second stiffness, wherein the first layer is disposed between the glass element and the second layer.

### Embodiment 5

The stack assembly of any one of embodiments 2-4, wherein the second stiffness is from 1×105 N/m to 3×105 N/m.

### Embodiment 6

A stack assembly, comprising:

a glass element comprising a thickness of less than or equal to 200 microns; and

a support layer adjacent to the glass element, the support layer comprising a first layer and a second layer,

wherein the first layer comprises a first stiffness of from 9×105 N/m to 2.0×106 N/m, and the second layer comprises a second stiffness of from 1×105 N/m to 3×105 N/m.

### Embodiment 7

The stack assembly of any one of embodiments 2 to 6 wherein the first stiffness is greater than or equal to two times the second stiffness.

### Embodiment 8

The stack assembly of any of the preceding embodiments, wherein the first layer comprises a first material and an adhesive material that joins the first material with the glass element.

### Embodiment 9

The stack assembly of embodiment 8, wherein the adhesive material comprises a thickness of from about 25 microns to about 50 microns.

The embodiments, and the features of those embodiments, as discussed herein are exemplary and can be provided alone or in any combination with any one or more features of other embodiments provided herein without departing from the scope of the disclosure. Moreover, it is to be understood that both the foregoing general description and the following detailed description present embodiments of the disclosure, and are intended to provide an overview or framework for understanding the nature and character of the embodiments as they are described and claimed. The accompanying drawings are included to provide a further understanding of the embodiments, and are incorporated into and constitute a part of this specification. The drawings illustrate various embodiments of the disclosure, and together with the description, serve to explain the principles and operations thereof.

### BRIEF DESCRIPTION OF THE DRAWINGS

FIG. 1 is a schematic side view of a Comparative Stack structure according to some embodiments.

FIG. 2 is a schematic side view of a stack structure according to some embodiments.

FIG. 3 is a schematic top view of a stack support structure according to some embodiments.

FIG. 4 is a schematic bottom view of the stack support structure of FIG. 3 according to some embodiments.

FIG. 5 is a schematic side view of the stack support structure of FIG. 3 (and a stack structure) according to some embodiments as taken along line 5-5 of FIG. 4.

FIG. 6 is a plot of load (in Newtons (N) on the Y-axis) versus displacement (in millimeters (mm) on the X-axis) for various materials, used to determine stiffness.

### DETAILED DESCRIPTION

In the following detailed description, for purposes of explanation and not limitation, example embodiments disclosing specific details are set forth to provide a thorough understanding of various principles and embodiments. However, it will be apparent to one having ordinary skill in the art, having had the benefit of the present disclosure, that the claimed subject matter may be practiced in other embodiments that depart from the specific details disclosed herein. Moreover, descriptions of well-known devices, methods and materials may be omitted so as not to obscure the description of various principles set forth herein. Finally, wherever applicable, like reference numerals refer to like elements.

Stack structures will now be described more fully hereinafter with reference to the accompanying drawings in which exemplary embodiments of the disclosure are shown. Whenever possible, the same reference numerals are used throughout the drawings to refer to the same or like parts. However, this disclosure may be embodied in many different forms and should not be construed as limited to the embodiments set forth herein. In some embodiments the stack structures may be used in a device for example an electronic device, for example a device having a sensor wherein the thin glass sheet is used as a cover for the sensor. The stack structures of the present disclosure greatly improve the puncture resistance or ability to absorb impact energy without failure, as measured with a pen drop test for example, of thin glass elements disposed at a user interface of a device.

Pen Drop Test.

One test for evaluating the puncture resistance of stack that includes a thin glass element, includes dropping a pen onto the stack from increasing heights until the glass fractures. The test is conducted as follows, and was used to measure pen drop heights disclosed herein. The samples were tested with the load imparted to the side of the stack having the thin glass element thereon, with the opposite side of the stack being supported by a polished aluminum plate (9.5 mm thick, grade 6061). The stack was simply set on the aluminum plate, no tape was used to couple the stack with the aluminum plate. A tube was used to guide the pen to the sample, and the tube sat on the top surface of the sample so that the longitudinal axis of the tube was generally perpendicular to the top surface of the sample. The tube had an outside diameter of 2.54 centimeter (cm) (1 inch) and an inside diameter of 1.4 cm (nine sixteenths of an inch). After each drop, the tube was relocated relative to the sample to guide the pen to a different impact location on the sample. All drops were performed near the center area of the sample, no drops were performed on the edge. The pen was a BIC, Easy Glide, Fine, having a ball point of 0.7 mm diameter, and a weight of 5.75 grams. The pen was dropped with the cap attached to the back end so that the ball point could interact with the test sample. The pen was first dropped from a height of 10 cm, and the height incremented by 5 cm per drop until the drop caused the thin glass element to fracture. The drop height causing fracture was then recorded. The maximum drop height was 75 cm. Thus, a pen drop height of 75 cm indicates that the thin glass element did not fracture during that test. The pen was changed to a new pen after every 5 drops, and for each new sample tested.

Although the pen drop test described above is an example of dynamic loading, one would generally expect that, directionally, given the characteristics and thicknesses of materials in the stack assembly, the test is indicative of the stack's ability to absorb energy without failing. That is, a stack assembly's ability to withstand a higher dynamic load than does another stack assembly is also generally indicative that it will withstand a higher static load as well, for example the static loading of other puncture resistance tests, for example pressing with a stainless steel tip or tungsten carbide ball.

Comparative Stack Structure

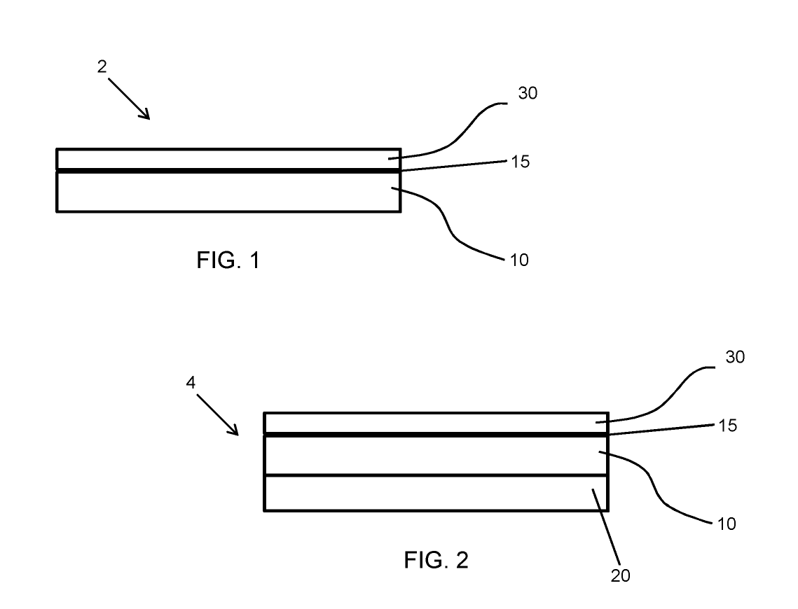

A structure of a comparative stack 2 is shown in FIG. 1. Comparative stack 2 includes a thin glass element 30 coupled to a first layer 10 via adhesive 15. In all embodiments of the comparative stack 2, the thin glass element 30 was 100 micrometer (hereinafter micrometer(s), micron(s), and/or μm) thick glass substrate made according to the processes set forth in U.S. Pat. No. 9,321,677 (available from Corning Incorporated, Corning, N.Y.).

### Comparative Example 1

In this example of comparative stack 2: first layer 10 was a 1.1 mm thick aluminosilicate glass having a stiffness of 1.6×10⁶ Newtons per meter (N/m); adhesive 15 was a 50 micron thick pressure sensitive adhesive (PSA) sheet available from 3M Corporation (St. Paul, Minn.) as code 8212. The stack had an average pen drop failure height of 34 cm (+/−8 cm).

### Comparative Example 2

In this example of comparative stack 2: first layer 10 was a 1.1 mm thick aluminosilicate glass having a stiffness of 1.6×10⁶ N/m; adhesive 15 was a 25 micron thick PSA sheet available from 3M Corporation (St. Paul, Minn.) as code 8211. The stack had an average pen drop failure height of 28 cm (+/−3 cm).

### Comparative Example 3

In this example of comparative stack 2: first layer 10 was a 4.8 mm thick piece of acrylonitrile butadiene styrene (ABS), trade name Kydex® T available from Kydex, LLC (Bloomsburg, Pa.) which has a stiffness of 9.4×10⁵ N/m, wherein the stiffness of this material is independent of thickness; adhesive 15 was a 50 micron thick PSA. This comparative stack had an average pen drop failure height of 10 cm+/−0.

### Comparative Example 4

In this example of comparative stack 2: first layer 10 was a 4.8 mm thick piece of ABS, trade name Kydex® T, which has a stiffness of 9.4×10⁵ N/m, wherein the stiffness of this material is independent of thickness; adhesive 15 was a 25 micron thick PSA. This comparative stack had an average pen drop failure height of 10 cm+/−0.

Comparing Comparative Example 1 with Comparative Example 2, as well as comparing Comparative Example 3 with Comparative Example 4, it is seen that whether the thickness of the adhesive 15 is 50 microns or 25 microns, the ability of the comparative stack 2 to absorb impact energy is about the same.

In general, one would ordinarily think that including a less stiff material in a stack would lead to a greater ability of the stack to absorb energy and, thus, a higher pen drop height. However, comparing Comparative Example 3 with Comparative Example 1 (or Comparative Example 4 with Comparative Example 2) it is seen that the use of the less stiff material of Example 3 (stiffness of 9.4×10⁶ N/m being less than the stiffness 1.6×10⁶ N/m of Comparative Example 1) actually had the opposite effect—the pen drop height dramatically decreased from about 30 cm to 10 cm.

From the study of Comparative Examples 1-4, the inventors found that simply supporting the thin glass element with a more compliant material (i.e., less stiff) was not sufficient to increase the puncture resistance of the thin glass element. Instead, upon impact (for example with a pen) the less stiff material allows biaxial flexure of the glass element, which leads to increased failure. Thus, the materials supporting the thin glass element needed to be configured in a different manner to improve the ability of the stack to resist puncture, i.e., increase the ability to absorb energy without failure.

The inventors found that using a two layer structure, with the layers appropriately configured relative to one another, allowed the stack to survive higher pen drop heights, i.e., the stack was able to absorb more load energy, without damage to the thin glass element. In some embodiments the stack includes a first layer coupled to the thin glass element on the side of the thin glass element disposed away from the user. The first layer may be coupled to the thin glass element by an adhesive, for example a PSA, for example a PSA having a thickness from 25 to 50 microns. If the adhesive becomes too thick, or too compliant, then there is a risk that the thin glass element will be subject to biaxial flexure and will not be able to absorb as much impact energy. The first layer is then supported by a second layer having less stiffness than the first layer.

The first layer should be stiff. The stiffness of the first layer should be high to increase resistance to biaxial flexure of the thin glass element. Biaxial flexure is the observed failure mode for thin glass elements during puncture events such as pen drop testing. The 1.1 mm thick aluminosilicate glass (with stiffness of 1.6×10⁶ N/m) outperformed the ABS with lower stiffness (9.4×10⁵ N/m) when pen drop testing these materials alone. Thus, higher stiffness of the first layer (supporting the thin glass element) reduces the ability of the thin glass element to bend locally and, thus, reduces the biaxial flexure stress.

Beneath the stiff first layer there can be disposed a second layer having low stiffness for energy absorption. Further, it is advantageous for the composite stiffness of the first layer and the second layer together to be low.

FIG. 2 shows a stack according to some embodiments. More specifically, stack 4 includes a thin glass element 30 coupled to a first layer 10 by an adhesive 15. The first layer 10 is, in turn, supported by a second layer 20. In all embodiments of the stack 4, the thin glass element 30 was 100 micron thick glass substrate made according to the processes set forth in U.S. Pat. No. 9,321,677 (available from Corning Incorporated, Corning, N.Y.).

### Example 1

In this example of stack 4: first layer 10 was a 1.1 mm thick piece of aluminosilicate glass, which had a stiffness of 1.6×10⁶ N/m; adhesive 15 was a 50 micron thick PSA; second layer 20 was an 0.8 mm thick piece of foamed polyethylene, wherein the combined stiffness of the first layer 10 and second layer 20 was 2.9×10⁵ N/m. Thin glass element 30 was 100 microns thick. This stack had an average pen drop failure height of 66 cm+/−8.

### Example 2

In this example of stack 4: first layer 10 was a 1.1 mm thick piece of aluminosilicate glass, which had a stiffness of 1.6×10⁶ N/m; adhesive 15 was a 25 micron thick PSA; second layer 20 was an 0.8 mm thick piece of foamed polyethylene, wherein the combined stiffness of the first layer 10 and second layer 20 was 2.9×10⁵ N/m. Thin glass element 30 was 100 microns thick. This stack had an average pen drop failure height of 49 cm+/−15.

As was seen above with Comparative Example 1 and Comparative Example 2, comparing Example 1 with Example 2, it is again seen that the thickness of the PSA can range from 25 microns to 50 microns without much statistically significant effect on the pen drop results. Accordingly, the adhesive coupling the first layer to the thin glass element can be 50 microns or less.

Further, comparing Examples 1 and 2 with Comparative Examples 1 and 2, respectively, it is seen that the former far outperformed the latter in pen drop height, indicating an increased ability to absorb energy upon impact. That is, a second (more compliant, less stiff) layer beneath the first layer allows the stack to absorb more impact energy before failure of the thin glass element, even when the stiffness of the first layer is the same. Further, comparing Examples 1 and 2 with Comparative Examples 3 and 4, respectively, when the first layer in a two layer stack is supported by a more compliant second layer, the first layer can be made of a stiffer material than would otherwise be thought possible. More specifically, the first layer in Examples 1 and 2 had a stiffness of 1.6×10⁶ N/m, which is higher than the stiffness (9.4×10⁵ N/m) of the first layer in Comparative Examples 3 and 4, yet the stack in Examples 1 and 2 had an increased pen drop height compared with that in Comparative Examples 3 and 4, thus indicating an advantageously increased ability to absorb impact energy.

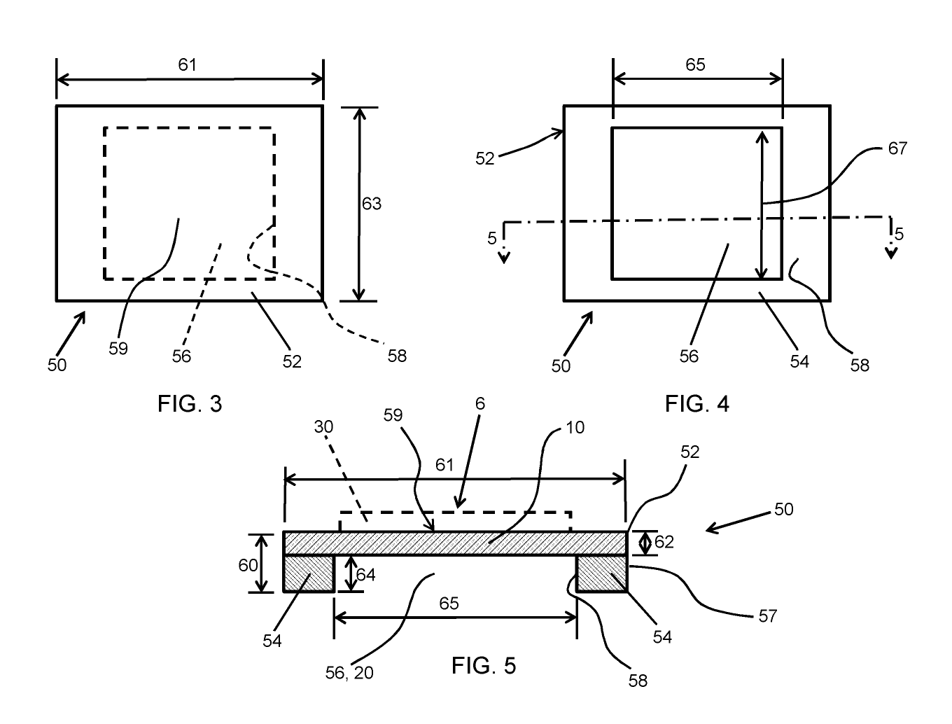

FIGS. 3-5 show a stack 6 according to some embodiments, wherein a second layer 20 may be made by fluid, for example air (or any other suitable gas, or in some embodiments by an evacuated space, and in other embodiments liquid), disposed underneath the first layer. More specifically, support 50 provides one example of how a second layer 20 may be made from gas disposed underneath first layer 10. Support 50 may include a cap 52, and a perimeter support 54. Cap 52 may be of a generally rectangular shape with a first dimension 61 and a second dimension 63. In some embodiments, first dimension 61 and second dimension 63 may be equal to one another, but such need not be the case as in other embodiments they can be unequal. Perimeter support 54 may be in the shape of a picture frame having an outer wall 57 and a cavity 56 at its center, wherein the cavity 56 is defined by a perimeter wall 58. Cavity 56 may have a first dimension 65 and a second dimension 67. In some embodiments the first dimension 65 and the second dimension 67 may be equal to one another, but such need not be the case as in other embodiments they can be unequal. A center portion 59 of cap 52 may be disposed over the cavity 56. The support 50 includes an overall thickness 60, whereas the cap 52 has a thickness 62 (which is also the thickness of the center portion 59), and the perimeter wall 54 has a thickness 64, which also corresponds to the thickness of the cavity 56. Accordingly, a first layer 10 with thickness 62 is formed of the center portion 59, and a second layer 20 of thickness 64 is formed of the gas (or other fluid) within cavity 56. According to some embodiments: the cap 52 may have a first dimension 61 of about 12.7 mm and a second dimension 63 of about 10.1 mm; the cavity 56 may have a first dimension 65 of about 7.2 mm and a second dimension 67 of about 7.2 mm; the thickness 60 may be about 4.8 mm, the thickness 62 may be about 1.8 mm, and the thickness 64 may be about 3 mm.

As shown in dashed lines, thin glass element 30 may be disposed on the center 59 of cap 52, thereby forming a stack 6 formed of thin glass element 30, first layer 10 (formed of the center 59 of cap 52), and second layer 20 (formed of air within cavity 56).

### Example 3

In this example of stack 6: first layer 10 was a 1.8 mm thick piece of ABS (formed by the center 59 of cap 52), which had a stiffness of 9.4×10⁵ N/m; second layer 20 was air (disposed within cavity 56), wherein the combined stiffness of the first layer 10 and second layer 20 was 1.0×10⁵ N/m. Thin glass element 30 was a 100 microns thick. This stack had an average pen drop failure height of 75 cm+/−0.

Comparing Example 3 with either one or both of Comparative Examples 3 and 4, when the first layer in a two layer stack is supported by a more compliant second layer, the first layer can be made of a stiffer material than would otherwise be thought possible. More specifically, the first layer in Example 3 had a stiffness of 9.4×10⁵ N/m, which is the same stiffness (9.4×10⁵ N/m) of the first layer in Comparative Examples 3 and 4, yet the stack in Example 3 had an increased pen drop height compared with that in Comparative Examples 3 and 4, thus indicating an advantageously increased ability to absorb impact energy.

Further, comparing Example 3 with either one or both of Examples 1 and 2, the ABS with hollow cavity (with a composite stiffness of 1×10⁵ N/m) outperformed the aluminosilicate with PE foam under-layer (having a higher composite stiffness of 2.9×10⁵ N/m. Accordingly, stacks having a lower composite stiffness (derived from combined stiffnesses of the first layer and the second layer) are better able to absorb impact energy (as evidenced by higher pen drop heights) thereby reducing failure to the thin glass element.

The effect of the stack configuration on increasing the puncture resistance of the glass element is largely independent of the area of the sample. That is, because the affected area around the impact event is millimeters at most, as long as the stiffnesses are present in that local area, the puncture resistance increasing effect will be attained for that area of the sample. Tested parts were on the order of 100 mm×150 mm and 150 mm×200 mm.

Thin Glass Element 30.

Although the thin glass element 30 described above in connection with the Comparative Examples 1-4, and Examples 1-3, was 100 microns thick piece of glass processed according to the principles in US patent glass substrate made according to the processes set forth in U.S. Pat. No. 9,321,677 (available from Corning Incorporated, Corning, N.Y.), such need not be the case. The concepts described herein can be used with other thin glass elements of different compositions and manners of making. For example, the thin glass element may be an alkali-free or alkali-containing aluminosilicate, borosilicate, boroaluminosilicate, or silicate glass composition, the glass element may be strengthened (for example thermally strengthened or chemically strengthened, for example ion-exchanged) but need not be, and may be a glass, a glass-ceramic, a ceramic material, or composites thereof. Additionally, the thin glass element need not be 100 microns thick. Generally, the concepts described herein can be used with glass elements having a thickness of less than or equal to 200 microns. That is, generally, as the glass element gets thicker, it will itself be more and more able to resist puncture events by itself and, therefore, the concepts described herein become less and less advantageous to improving the puncture resistance of that particular glass element. For example, the glass element may have a thickness of 200 microns, 190 microns, 180 microns, 175 microns, 170 microns, 160 microns, 150 microns, 140 microns, 130, microns, 125 microns, 120 microns, 110 microns, 100 microns, 90 microns, 80 microns, 75 microns, 70 microns, 60 microns, 50 microns, 40 microns, 30 microns, 25 microns, 20 microns, or 10 microns, or any sub-ranges between any of the foregoing listed thicknesses.

First Layer 10.

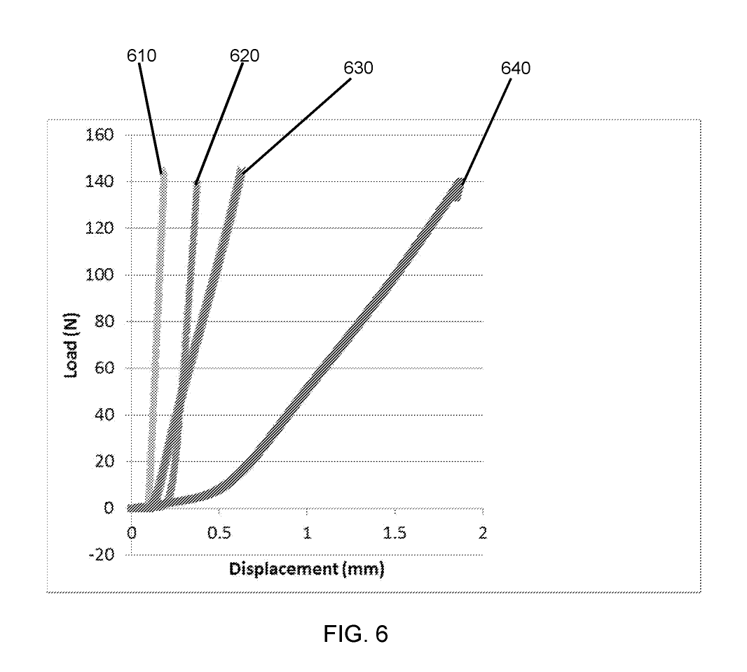

The first layer 10 may be made of various materials, provided the material has sufficient stiffness to (when in combination with any adhesive layer 15 that may be present) prevent undue biaxial flexure of the thin glass element 30. For example: the stiffness of the first layer may range from 9×10⁵ N/m to 2.0×10⁶ N/m, as measured with respect to the aluminosilicate glass and ABS material described below in “Stiffness Measurements”. In some embodiments, the material for layer 10 is at least about two times stiffer than the material used for layer 20. The thickness of the first layer 10 is not particularly limited in that the stiffness is more important than the thickness to preventing undue biaxial flexure. Thus, as long as the load remains along the linear part of the load-displacement curve for the particular material (see FIG. 6), the effect of limiting biaxial flexure will be independent of the thickness of the material. Thus, the thickness may be chosen according to the requirements for its application in a particular stack. Examples of materials that may be used for first layer 10 include aluminosilicate glass and ABS.

Second Layer 20

The second layer 20 may be made of various materials, provided they have sufficient energy absorbing capacity to allow some movement or deflection of the first layer as a whole, i.e., without the first layer locally bending at too tight a radius wherein it would allow biaxial flexure of the thin glass element. That is, as more readily envisioned with the embodiments depicted in FIGS. 3-5, the center of the first layer 10 may bend, albeit at a large radius of curvature (large enough to avoid biaxial flexure of thin glass element 30), instead of moving up and down as a completely planar object. For example: the stiffness of the second layer 20 may be up to half that of the first layer 10. Examples of materials that may be used for second layer 20 include: foamed polyethylene, fluid, gas, air, evacuated space, liquid, gel. Because of the low stiffness of the second layer, the material of the second layer was not measured directly via ball impacting into the material, but instead was measured as part of a stack as described below with respect to the foamed polyethylene in the section entitled in “Stiffness Measurement”. When measured as described below, the stiffness of the second layer 20 may be from 1×10⁵ N/m to 3×10⁵ N/m. The thickness of the second layer 20, similarly to that of the first layer 10, is not particularly limited in that the stiffness is more important than the thickness to energy absorbing capacity. Thus, as long as the load remains along the linear part of the load-displacement curve for the particular material (see FIG. 6), the effect of energy absorbing capacity will be independent of the thickness of the material. Thus, the thickness may be chosen according to the requirements for its application in a particular stack.

Stiffness Measurements

The stiffness of materials used in a stack was determined as follows. A 16 mm diameter tungsten carbide ball was pressed into the surface of the layer or multi-layer element being measured. The displacement was measured as a function of load from 0 to 140 N, and plotted as shown in FIG. 6. The stiffness measurement was made from the slope of the plot (change in load/change in displacement) from 20 to 140 N. As seen from FIG. 6: line 610 is a plot for a 1.1 mm thick piece of aluminosilicate glass, which has a stiffness of 1.6×10⁶ N/m; line 620 is a plot for a piece of ABS material, trade name Kydex® T which has a stiffness of 9.4×10⁵ N/m, wherein the stiffness of this material was independent of thickness; line 630 is a plot for a 1.1 mm thick piece of aluminosilicate glass with a 0.8 mm thick foamed polyethylene (PE) layer supporting the aluminosilicate glass (i.e., disposed between the glass and the test stage so that the tungsten carbide ball pressed on the sample on the side of the glass), wherein this two layer structure had a stiffness of 2.9×10⁵ N/m; line 640 is a plot for a piece of ABS material, trade name Kydex® T, which had a thickness of 1.8 mm and was supported around its edges (as described in connection with FIGS. 3-5) so as to be disposed over a cavity of air having a thickness of 3 mm, with the resulting stiffness at its center (over the cavity of air) of 1.0×10⁵ N/m.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, such as within about 5% of each other, or within about 2% of each other.

It will be apparent to those skilled in the art that various modifications and variations can be made to the present disclosure without departing from the spirit and scope of the disclosure. Thus, it is intended that the present invention cover the modifications and variations of this disclosure provided they come within the scope of the appended claims and their equivalents.

For example, although the first layer 10 was shown as only one layer, it may itself be a composite of more than one layer presenting a combined thickness and composite stiffness derived from the thicknesses and stiffnesses of the layers from which it is made. Similarly, although the second layer 20 was shown as only one layer, it may itself be a composite of more than one layer presenting a combined thickness and composite stiffness derived from the thicknesses and stiffnesses of the layers from which it is made. Still further, although the adhesive 15 was shown as only one layer, it may itself be a composite of more than one layer presenting a stiffnesses of the layers from which it is made.

Further, for example, although the second layer 20 was described as having the same general shape as the first layer 10, such need not be the case. In order to provide a varied ability to absorb energy, the second layer 20 may have a different shape than the first layer 10; for example by combining the configurations of the embodiments of FIGS. 2-5. More specifically, the second layer 20 may be made of a material having a lower stiffness than that of the first material 10 (as with the embodiments of FIG. 2) but also have a frame-type configuration (as with the perimeter support 54 of FIGS. 3-5), thereby providing two different stiffnesses, each less than that of the first layer 10.

Still further, for example, although the support 50 (as well as each the cap 52 and perimeter support 54) was described as being rectangular, other shapes are possible, for example, elliptical, triangular, polygonal. Additionally, although the cap 52 was described as having a similar shape as either one or both of the perimeter support 54 and the cavity 56, such need not be the case; they may have different shapes in some embodiments (including a cavity 56 whose shape is not similar to that of the outer wall 57 of perimeter support 54, for example, wherein the cavity perimeter wall(s) are not parallel to the outer wall (s) 57 of the perimeter support 54). Moreover, although the cap 52 and support 54 were described as being two separate pieces, such need not be the case; they may be formed as a monolith; or they may be formed as two separate pieces bonded to one another.

For example, although the layers were described as sheet, they need not be. Instead, the layers may be webs of indeterminate length and the product rolled for storage and distribution

For example, one or more layers 10, 15, and/or 20, may include decorative elements that may be visible through one or more sides of the stack, particularly through the glass element 30.

For example, although no adhesive was present between the first layer 10 and the second layer 20, adhesive could be present. In the event that adhesive is present between the first layer 10 and the second layer 20, the stack configuration will still increase the puncture resistance of the glass element (all other things being equal) as long as the adhesive stiffness is small enough so that the stiffness of the second layer 20 dominates the impact event loading. That is, similarly to the adhesive 15 having little impact on the ability of the layer 10 to support the glass element to resist biaxial flexure, the adhesive between layers 10 and 20 can be chosen to have little impact on the ability of the layer 20 to absorb energy of the impact.

1. A stack assembly, comprising:
a glass element comprising a thickness of less than or equal to 200 microns; and
a support layer adjacent to the glass element, the support layer comprising a first layer and a second layer,
wherein the first layer comprises a first stiffness of from 9×10⁵ N/m to 2.0×10⁶ N/m, and the second layer comprises a second stiffness of from 1×10⁵ N/m to 3×10⁵ N/m.

2. A stack assembly, comprising:
a glass element comprising a thickness of less than or equal to 200 microns, the glass element comprising a first pen drop height value when directly adjacent a solid aluminum stage; and
a first layer adjacent the glass element, the first layer comprising a stiffness of from 9×10⁵ N/m to 2.0×10⁶ N/m,
wherein the glass element comprises a second pen drop height when directly adjacent the first layer which in turn is directly adjacent the solid aluminum stage, and wherein the second pen drop height value is greater than the first pen drop height value.

3. A stack assembly, comprising:
a glass element comprising a thickness of less than or equal to 200 microns;
a support layer adjacent to the glass element, the support layer comprising a first layer and a second layer, wherein the first layer comprises a first stiffness, and the second layer comprises a second stiffness, wherein the first stiffness is greater than the second stiffness;
wherein when the glass element is disposed on top of the first layer which, in turn, is directly adjacent a solid aluminum stage, the glass element comprises a first pen drop height value; and
wherein when the glass element is disposed on top of the first layer which, in turn, is disposed on top of the second layer which, in turn is directly adjacent the solid aluminum stage, the glass element comprises a second pen drop height value, wherein the second pen drop height value is greater than two times the first pen drop height value.

4. The stack assembly of claim 3, wherein the first stiffness is from 9×10⁵ N/m to 2.0×10⁶ N/m.

5. The stack assembly of claim 2, further comprising a second layer comprising a second stiffness, wherein the first layer is disposed between the glass element and the second layer.

6. The stack assembly of claim 3, wherein the second stiffness is from 1×10⁵ N/m to 3×10⁵ N/m.

7. The stack assembly of claim 1 wherein the first stiffness is greater than or equal to two times the second stiffness.

8. The stack assembly of claim 1, wherein the first layer comprises a first material and an adhesive material that joins the first material with the glass element.

9. The stack assembly of claim 8, wherein the adhesive material comprises a thickness of from about 25 microns to about 50 microns.
